(19) United States
(12) Patent Application Publication
(10) Pub. No.: US 2025/0340797 A1
(43) Pub. Date: Nov. 6, 2025

(54) CANDLE MANUFACTURING APPARATUS

(71) Applicant: Philip Clarke, Cheltenham (CA)

(72) Inventor: Philip Clarke, Cheltenham (CA)

(21) Appl. No.: 18/653,338

(22) Filed: May 2, 2024

(51) Int. Cl. C11C 5/02

(52) U.S. Cl. CPC C11C 5/023

(57) ABSTRACT

A candle manufacturing apparatus that utilizes a mold body to provide a contiguous connection of three candle members through a common interior volume present in the mold body. The mold body includes a center portion that is tubular in shape having a first end and a second end. Integrally formed with the center portion 12 is a first arm member wherein the first arm member is axially aligned with the center portion extending outward therefrom. A second arm member is integrally formed with the center portion opposite the first arm member. The second arm member extends outward from the center portion and is axially aligned therewith. The first arm member, second arm member and center portion have openings providing access to the interior volume and a void to insert the candle members thereinto. Apertures are formed at the ends of the first arm member, second arm member and center portion.

### FIELD OF THE INVENTION

The present invention relates generally to candle manufacturing, more specifically but not by way of limitation, a candle mold that is configured to provide an operable connection with three candles wherein the present invention facilitates a continuous connection of wax in a base mold with three vertically oriented and spaced candles extending outward from the base mold.

### BACKGROUND

Candles have been utilized for centuries for various tasks such as but not limited to light, heat and aromatic influence for an area proximate to the candle. Candles play an important role in some religions wherein the candle is utilized in various ceremonial celebrations such as but not limited to mass celebrations in the Catholic church. Different types of candles are utilized for different tasks either during a mass celebration or at a place of worship. Candles such as but not limited to Easter candles are typically placed at the altar and are quite large. Other smaller candles are employed during entrance processions and at other times during mass celebration.

One task where clergy utilize candles is during the blessing of the holy water. During this ritual, the clergy member will utilize a candle that has three vertical candle members wherein the three candles represent the holy trinity. The candle must have a contiguous connection across the three candles in order to be compliant with religious customs. Manufacturing of a candle that has three candle members and yet a common base that is operably coupled thereto is extremely cumbersome and time consuming. Traditional methods of manufacturing a triple candle that is compliant with religious protocols can take on average about one to two weeks. These conventional methods have proven to inefficient from an operations perspective and are cost prohibitive as well.

Accordingly, there is a need for a candle manufacturing apparatus that is operable to produce a triple candle having a contiguous base portion operably coupling all three candle members.

### SUMMARY OF THE INVENTION

It is the object of the present invention to provide a candle manufacturing apparatus that is operable to produce a triple candle wherein the candle has a contiguous base portion wherein the present invention includes a mold body.

Another object of the present invention is to provide a mold for manufacture of a candle having at least two candle members wherein the mold body includes a center portion wherein the center portion is cylindrical in shape having a hollow passage therethrough.

A further object of the present invention is to provide a candle manufacturing apparatus that is operable to produce a triple candle wherein the center portion has contiguously formed therewith a first arm member wherein the arm member is axially aligned with the center portion and extends outward therefrom.

Yet a further object of the present invention is to provide a mold for manufacture of a candle having at least two candle members wherein the present invention includes a second arm member contiguously formed with the center portion on the opposing side from the first arm member.

Still another object of the present invention is to provide a candle manufacturing apparatus that is operable to produce a triple candle wherein the center portion includes a lower section wherein the lower section is releasably secured to the center portion.

An additional object of the present invention is to provide a mold for manufacture of a candle having at least two candle members wherein the lower section includes a decorative member formed on the end thereof.

Yet a further object of the present invention is to provide a candle manufacturing apparatus that is operable to produce a triple candle wherein the present invention includes apertures proximate the opening of the first arm member, center portion and second arm member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top perspective view of the mold body of the present invention; and

FIG. 2 is a side view of the mold body of the present invention; and

FIG. 3 is a side view of the mold body of the present invention; and

FIG. 4 is a side view of the mold body of the present invention having a decorative lower member secured thereto;

FIG. 5 is a bottom perspective view of the mold body with the releasably secured lower section.

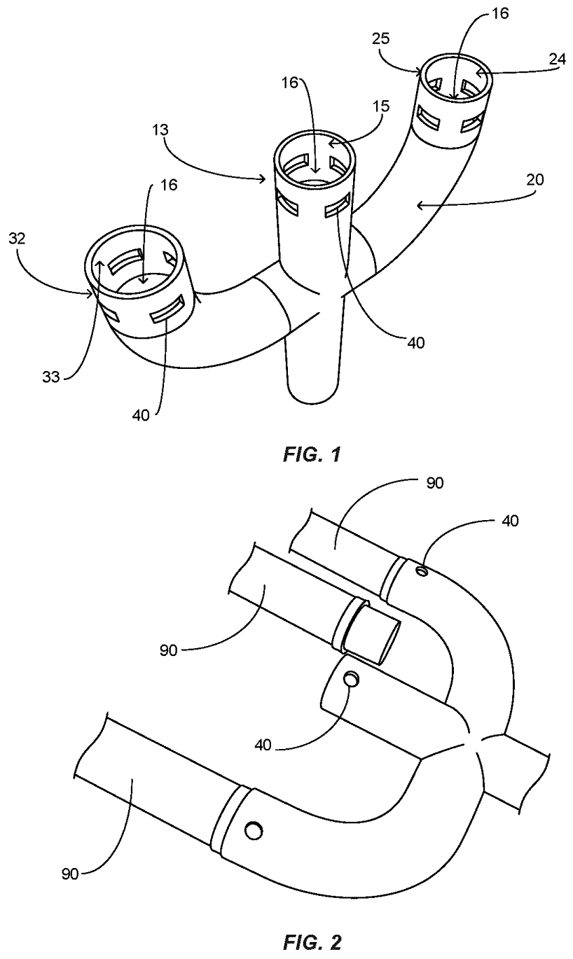

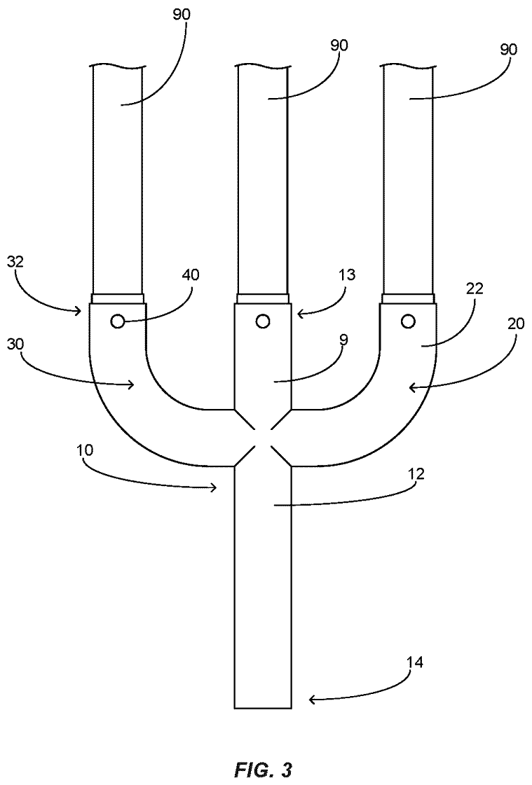

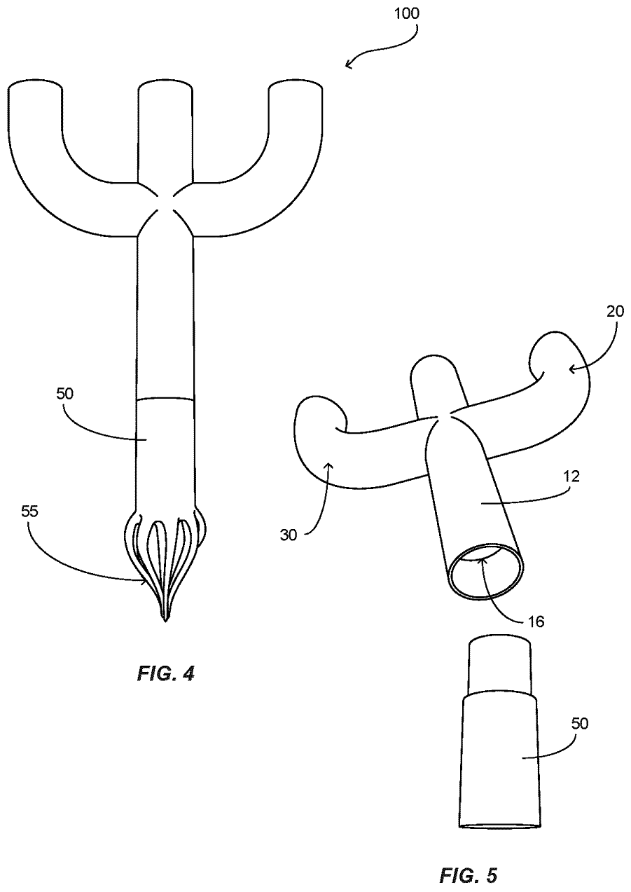

### DETAILED DESCRIPTION

Referring now to the drawings submitted herewith, wherein various elements depicted therein are not necessarily drawn to scale and wherein through the views and figures like elements are referenced with identical reference numerals, there is illustrated a candle manufacturing apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the candle manufacturing apparatus 100 includes a mold body 10 that is manufactured from a suitable durable material such as but not limited to plastic. While the ensuing discussion of the candle manufacturing apparatus 100 is for the embodiment of a triple candle configuration, it should be understood within the scope of the present invention that the mold body 10 could be provided in embodiments that provide a configuration for more or less than three candle members. As is further discussed herein, the mold body 10 provides a contiguous connection of three candle members 90 through a common interior volume 16.

The mold body 10 includes a center portion 12. The center portion 12 is tubular in shape having a first end 13 and a second end 14. The center portion 12 includes opening 15 proximate the first end 13 providing access to the hollow interior volume 16 of the mold body 10. The mold body 10 is completely hollow throughout all of the elements discussed herein so as to be filled with wax during the candle manufacturing process. While the mold body 10 illustrated herein shows tubular shaped elements, it is contemplated within the scope of the present invention that the mold body 10 could have integrally formed elements of alternate shapes. Additionally, it should be understood within the scope of the present invention that the mold body 10 could be provided in alternate sizes.

Integrally formed with the center portion 12 is the first arm member 20. The first arm member 20 is operably coupled to the center portion 12 and is axially aligned therewith extending outward therefrom. The first arm member 20 in a preferred embodiment is arcuate in shape creating upper section 22 that is aligned with the upper section 9 of the center portion 12 having an equal height thereto. The first arm member 20 includes opening 24 at end 25 providing access to the common interior volume 16 of the mold body 10. While the preferred embodiment of the first arm member 20 is arcuate in shape, it is contemplated within the scope of the present invention that the first arm member 20 could be provided in alternate shapes. By way of example but not limitation, the first arm member 20 could be formed having two integral sections that are perpendicular.

The mold body 10 further includes a second arm member 30. The second arm member 30 is integrally formed with the center portion 12 on the opposing side thereof from the first arm member 20. The second arm member 30 is axially aligned with the center portion 12 and extends outward therefrom. The second arm member 30 includes end 32 having opening 33 providing access to the interior volume 16 of the mold body 10. The second arm member 30 has an equivalent radius to the arcuate form thereof. As with the first arm member 20, it is contemplated within the scope of the present invention that the second arm member 30 could be provided in alternate shapes. While the mold body 10 includes a second arm member 30 and a first arm member 20 to accommodate three candle members 90, it is contemplated within the scope of the present invention that the mold body 10 could be constructed to accommodate two candle members or more than three candle members.

The mold body 10 includes apertures 40 formed proximate the end 32, first end 13 and end 25. The apertures 40 are placed proximate the end 32, first end 13 and end 25 in order for a user of the candle manufacturing apparatus 100 to insert wax thereinto. Wax is inserted into apertures 40 during manufacture of a candle wherein the wax inserted into the apertures 40 is deposited into the interior volume 16 and the candle members 90 are subsequently inserted providing a contiguous connection between the interior volume 16 and the three candle members 90 as the wax extends completely through the interior volume 16 present in the center portion 12, first arm member 20 and second arm member 30.

The center portion 12 of the candle manufacturing apparatus 100 includes lower section 50. The lower section 50 is manufactured of the same size and material of the center portion 12 and is configured to be releasably secured thereto. The lower section 50 can be removed for permitting access to the interior volume 16 of the mold body 10. It is contemplated within the scope of the present invention that the lower section 50 could be releasably secured to the center portion 12 employing various suitable techniques and/or elements. It is further contemplated within the scope of the present invention that the lower section 50 could have formed on the end thereof a decorative member 55. Decorative member 55 could be releasably secured or integrally formed with the lower section 50. It should be understood within the scope of the present invention that the decorative member 55 could be formed in a multitude of designs, shapes and sizes.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A candle manufacturing apparatus configured to provide a contiguous connection of multiple candle members through a common interior volume wherein the candle manufacturing apparatus comprises:
a mold body, said mold body having a center portion, said center portion having a first end and a second end, said center portion having an opening proximate said first end, said center portion being hollow having an interior volume, said center portion having integrally formed therewith at least one arm member, said at least one arm member being axially aligned with said center portion extending outward therefrom, said at least one arm member having an interior volume operably coupled with the interior volume of said center portion, said opening of said at least one arm member providing access to the interior volume of said at least one arm member; and
wherein the interior volume of the mold base is contiguous throughout said center portion, said at least one arm member.

2. The candle manufacturing apparatus configured to provide a contiguous connection of multiple candle members through a common interior volume as recited in claim 1, and further including a first candle member and a second candle member.

3. The candle manufacturing apparatus configured to provide a contiguous connection of multiple candle members through a common interior volume as recited in claim 2 wherein said first candle member is operably coupled with the opening of said at least one arm member.

4. The candle manufacturing apparatus configured to provide a contiguous connection of multiple candle members through a common interior volume as recited in claim 3, wherein said second candle member is operably coupled with the opening of said center portion proximate the first end of the center portion.

5. The candle manufacturing apparatus configured to provide a contiguous connection of multiple candle members through a common interior volume as recited in claim 4, wherein said center portion further includes a lower section, said lower section releasably secured to said second end of said center portion.

6. The candle manufacturing apparatus configured to provide a contiguous connection of multiple candle members through a common interior volume as recited in claim 5, wherein said at least one arm member further includes apertures formed therein proximate said openings thereof.

7. The candle manufacturing apparatus configured to provide a contiguous connection of multiple candle members through a common interior volume as recited in claim 6, wherein said center portion further includes apertures formed therein proximate the opening at the first end thereof.

8. The candle manufacturing apparatus configured to provide a contiguous connection of multiple candle members through a common interior volume as recited in claim 7, and further including a decorative element, said decorative element being contiguously formed with said lower section.

9. A candle manufacturing apparatus configured to provide a contiguous connection of multiple candle members through a common interior volume wherein the candle manufacturing apparatus comprises:
a mold body, said mold body having a center portion, said center portion having a first end and a second end, said center portion having an opening proximate said first end, said center portion being hollow having an interior volume, said center portion having integrally formed therewith a first arm member, said first arm member being axially aligned with said center portion extending outward therefrom, said first arm member having an interior volume operably coupled with the interior volume of said center portion, said mold body further having a second arm member, said second arm member being integrally formed with said center portion opposite said first arm member, said second arm member having an interior volume operably coupled with the interior volume of said center portion, said second arm member extending outward from said center portion, said first arm member having an opening distal to said center portion, said second arm member having an opening distal to said center portion, said opening of said first arm member providing access to the interior volume of said first arm member, said opening of said second arm member providing access to the interior volume the second arm member; and
wherein the interior volume of the mold base is contiguous throughout said center portion, said first arm member and said second arm member.
